(19) United States
(12) Patent Application Publication
(10) Pub. No.: US 2010/0100461 A1
(43) Pub. Date: Apr. 22, 2010

(54) PAYMENT TRANSACTION SYSTEM

(75) Inventors: Michael Thomas Laing, Armadale (AU); Justin Clifford Breeze, Toorak (AU)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: TXN Pty Ltd

(21) Appl. No.: 12/560,014

(22) Filed: Sep. 15, 2009

Related U.S. Application Data
(63) Continuation-in-part of application No. PCT/AU2007/000322, filed on Mar. 16, 2007.

(51) Int. Cl. G06Q 20/00; G06Q 10/00; G06F 15/16; G06Q 40/00

(52) U.S. Cl. 705/30; 705/44; 709/204

(57) ABSTRACT

A payment transaction system, including a transaction exchange for:
(a) registering and certifying account keepers for maintaining accounts and authorising payment transactions on behalf of entities;
(b) storing account keeper identification (ID) data;
(c) receiving a payment transaction, said transaction including ID data for a registered account keeper and an account associated with a payer making a payment of the transaction, and ID data for a registered account keeper and an account associated with a receiver receiving the payment;
(d) determining validity of the transaction based on the ID data; and
(e) authorising the transaction with the account keeper associated with the payer.

### RELATED APPLICATION(S)

This application claims priority to and is a continuation-in-part of International Application No. PCT/AU2007/000322, which designated the United States and was filed on Mar. 16, 2007, published in English.

The entire teachings of the above application(s) are incorporated herein by reference.

### BACKGROUND OF THE INVENTION

The current infrastructure and transaction systems associated with the processing of electronic payments have been established and built on the basis of the relationships and obligations between the various parties involved in the transactions. The parties include consumers, merchants, transaction service or scheme providers, such as credit card, debit card or charge card issuers, and transaction acquirers such as financial institutions (e.g. banks). With the exception of consumers (who may only have to manage one or more transaction accounts) the parties have developed a wide variety of sophisticated electronic systems and interfaces to process large volumes of transactions. Examples include the systems developed to support the payment schemes and transactions of American Express Company, Diners Club International Ltd, Visa International Service Association, and MasterCard Worldwide, and the Electronic Funds Transfer Point Of Sale (EFTPOS) system that operates in Australia, INTERAC in Canada and NETS in Singapore.

A number of transaction systems support the roles of “issuer”, “acquirer” and “scheme provider”. An issuer is a party that issues another party with a transaction account, such as a credit, debit or charge card account. A scheme provider is a party that defines the transaction process associated with a transaction scheme for handling payment transactions. The scheme provider would typically determine the fees that pass between various parties in handling a payment transaction. An acquirer normally provides equipment to receive the payment transaction and attend to settlement of the transaction, including settlement of payment of various fees between the parties. Acquirers may also (depending on the scheme under which the transaction is processed) bear many of the risks associated with the transaction, including issuer settlement risk, merchant fraud, and failure by the merchant to deliver the goods or services purchased. An acquirer is considered to receive and accept transactions. Depending on the transaction scheme, an issuer, an acquirer and a scheme provider may be different respective parties or the roles performed in combination by one or more of the parties. For example, for a Visa scheme, a bank may act as an acquirer and issuer, whereas Visa International Service Association acts as a scheme provider, yet for an American Express scheme, American Express Company may perform all three roles in combination, depending on the transaction.

A common feature of the existing transaction systems is that payers of payment transactions, typically consumers, and receivers of transactions, typically merchants, generally have little discretion or influence over the equipment to be used and how electronic transactions are going to be performed. A merchant also typically pays a merchant service fee for each transaction, which is normally either a percentage of the value or amount of the transaction or a fixed fee per transaction or both. An acquirer may also pay an interchange fee to an issuer, which is again either a percentage of the transaction amount or a fixed fee per transaction or both, and this is included as part of the merchant service fee. In some cases, it is the issuer who pays an interchange fee to an acquirer rather than the other way around. The interchange fee is defined by the scheme, and is incurred and paid as part of payment processing by the transaction systems, regardless of whether one or more parties act as the issuer and acquirer. The systems include interfaces for processing both the merchant service fee and the interchange fee, regardless of whether the issuer and acquirer are the same party. For some schemes, such as American Express, where the issuer and the acquirer are the same party, there is no explicit interchange fee separately identified and charged but the merchant service fee is set at a level that it covers both issuing and acquiring requirements.

Accordingly, it is desired to provide at least a useful alternative, and in particular a system that provides merchants and consumers discretion or influence over the equipment to be used and how electronic transactions are performed, as well as the ability to determine the terms on which transactions are processed. This will obviate the need for many of the processes and interfaces associated with many current roles including acquirer, issuer, and scheme provider.

### SUMMARY OF THE INVENTION

The current infrastructure and transaction systems associated with the processing of electronic payments have been established and built on the basis of the relationships and obligations between the various parties involved in the transactions. The parties include consumers, merchants, transaction service or scheme providers, such as credit card, debit card or charge card issuers, and transaction acquirers such as financial institutions (e.g. banks). With the exception of consumers (who may only have to manage one or more transaction accounts) the parties have developed a wide variety of sophisticated electronic systems and interfaces to process large volumes of transactions. Examples include the systems developed to support the payment schemes and transactions of American Express Company, Diners Club International Ltd, Visa International Service Association, and MasterCard Worldwide, and the Electronic Funds Transfer Point Of Sale (EFTPOS) system that operates in Australia, INTERAC in Canada and NETS in Singapore.

A number of transaction systems support the roles of “issuer”, “acquirer” and “scheme provider”. An issuer is a party that issues another party with a transaction account, such as a credit, debit or charge card account. A scheme provider is a party that defines the transaction process associated with a transaction scheme for handling payment transactions. The scheme provider would typically determine the fees that pass between various parties in handling a payment transaction. An acquirer normally provides equipment to receive the payment transaction and attend to settlement of the transaction, including settlement of payment of various fees between the parties. Acquirers may also (depending on the scheme under which the transaction is processed) bear many of the risks associated with the transaction, including issuer settlement risk, merchant fraud, and failure by the merchant to deliver the goods or services purchased. An acquirer is considered to receive and accept transactions. Depending on the transaction scheme, an issuer, an acquirer and a scheme provider may be different respective parties or the roles performed in combination by one or more of the parties. For example, for a Visa scheme, a bank may act as an acquirer and issuer, whereas Visa International Service Association acts as a scheme provider, yet for an American Express scheme, American Express Company may perform all three roles in combination, depending on the transaction.

A common feature of the existing transaction systems is that payers of payment transactions, typically consumers, and receivers of transactions, typically merchants, generally have little discretion or influence over the equipment to be used and how electronic transactions are going to be performed. A merchant also typically pays a merchant service fee for each transaction, which is normally either a percentage of the value or amount of the transaction or a fixed fee per transaction or both. An acquirer may also pay an interchange fee to an issuer, which is again either a percentage of the transaction amount or a fixed fee per transaction or both, and this is included as part of the merchant service fee. In some cases, it is the issuer who pays an interchange fee to an acquirer rather than the other way around. The interchange fee is defined by the scheme, and is incurred and paid as part of payment processing by the transaction systems, regardless of whether one or more parties act as the issuer and acquirer. The systems include interfaces for processing both the merchant service fee and the interchange fee, regardless of whether the issuer and acquirer are the same party. For some schemes, such as American Express, where the issuer and the acquirer are the same party, there is no explicit interchange fee separately identified and charged but the merchant service fee is set at a level that it covers both issuing and acquiring requirements.

Accordingly, it is desired to provide at least a useful alternative, and in particular a system that provides merchants and consumers discretion or influence over the equipment to be used and how electronic transactions are performed, as well as the ability to determine the terms on which transactions are processed. This will obviate the need for many of the processes and interfaces associated with many current roles including acquirer, issuer, and scheme provider.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

Preferred embodiments of present invention are hereinafter described, by way of example only, with reference to the accompanying drawings, wherein:

FIG. 1 is a diagram of a preferred embodiment of a payment transaction system;

FIG. 2 is a diagram of an identity authenticator and guarantor registration process of the system;

FIG. 3 is a diagram of a registration process for a payment enabler of the system;

FIG. 4 is a diagram of a registration process for account keeper;

FIG. 5 is a diagram of an account keeper service process for a payer;

FIG. 6 is a diagram of an account keeper service process for a receiver;

FIG. 7 is a diagram of a registration process for a payment enabler supplied to a payer or receiver;

FIG. 8 is a diagram of a fund manager and a fund provider service process;

FIG. 9 is a diagram of an enhancement service provider process;

FIG. 10 is a diagram of a payment transaction process for a payment initiated by a receiver;

FIG. 11 is a diagram of a payment transaction process initiated by a payer;

FIG. 12 is a diagram of an enhancement service access process;

FIG. 13 is a diagram of an enhancement service access process supported by a receiver.

### DETAILED DESCRIPTION OF THE INVENTION

A description of example embodiments of the invention follows.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

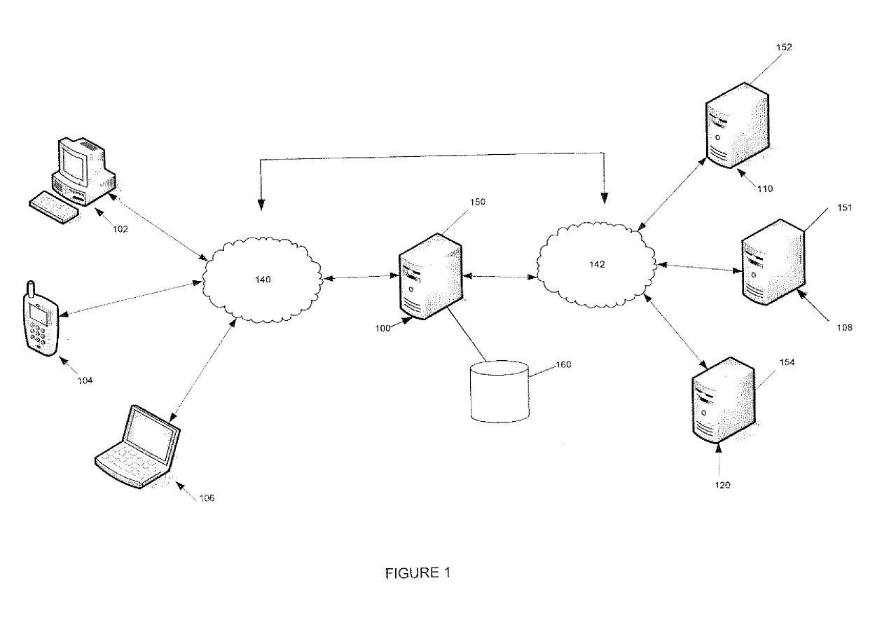

A payment transaction system, as shown in FIG. 1, is based on a transaction exchange (TX) 100, as shown in FIG. 1, that is able to communicate with one or more payment devices 102, 104, 106 to accept and process payment transactions. The payment devices 102, 104, 106 support communication interfaces to both initiate and complete payment transactions. The devices may support payers of transactions, receivers of transactions or both. The payments devices are computer devices, such as EFTPOS terminals 102 at a merchant's premises, wireless devices 104, such as cellular phones and personal digital assistants (PDA), and personal computers 106, able to communicate with the transaction exchange 100 using a communications network 140.

The transaction exchange 100, in addition to communicating with a payment device 102, 104, 106, is also able to communicate with the systems 108, 110, 120 of other parties over a communications network 142, such as a server 151 of an account keeper, the server 152 of an enhancement service provider or the server 154 of a financial institution that may act as a fund manager/fund provider or the server (not shown) of any other entity of the system. An enhancement service provider would offer payers and/or receivers additional services for purchase in association with individual payment transactions. The communications networks 140, 142 may be the same or include similar elements, or alternatively one network 140 may use a more open architecture, such as one based on the Internet Protocol (IP) suite of protocols (for example the Internet, a WiFi network etc) and the other network 142 may be more closed or proprietary, such as a LAN or WAN architecture (this may include an Electronic Funds Transfer network based on ISO 8583 or on the Australian Standards AS 2805). The transaction exchange 100, and the systems 108, 110 and 120, may be provided using one or more computer servers 150, 151, 152, 154, such as those produced by IBM Corporation or Apple Inc., running an operating system such as Windows Server or Mac OS X. The servers 150, 151, 152, 154 also include communication components and interfaces, such as a web server (e.g. Apache), to support the use of communication protocols in order to communicate with servers and devices 102 to 106 over the communications networks 140, 142. The transaction exchange 100 includes one server 150 or a number of servers that can be co-located or distributed over the communication networks 140, 142. A number of transaction exchanges 100 may also be employed in the payment system.

A transaction exchange 100 processes transactions on behalf of payers and receivers, and establishes and manages processing with account keepers that manage accounts on behalf of payers and receivers. The accounts are maintained on the server 151 of an account keeper, but can be maintained on the transaction exchange 100 or on other servers 152, 154. The transaction exchange 100 communicates directly with the devices 102, 104, 106 used by payers and receivers to initiate and complete transactions without the reliance on systems that support the roles of issuer, acquirer and scheme operator. As will be apparent from the description below, the payment system supported by the transaction exchange 100 allows an account keeping role to be independent of the provider of a credit or debit card/facility, payment terminal or other payment enabler. The account keeping role can also be independent of the provider of any financial services associated with an individual account. The transaction processing performed is independent to the extent that payers and receivers of transactions can independently determine: (i) the manner in which payments are processed by the transaction exchange; and (ii) any enhancement services that can be associated with these transactions. The system obviates the need for fees or charges, particularly interchange fees, between payers and receivers or between their respective service providers. The only fees or charges are between receivers and their service providers, and between payers and their service providers, and between the transaction exchange 100 and entities registered with the transaction exchange 100. Fees are only exchanged between parties that have a direct relationship with one another, i.e. a fee is not collected by one party that is imposed by a third party. Also, as described below, the transaction processing does not distinguish nor is it distinguished by the underlying form of the account accessed, e.g. credit versus debit accounts.

The transaction exchange 100 maintains a database 160, using a database server such as MySQL, to process, establish and maintain entity records for the participants of or the parties to payment transactions. The entities include:
(a) Payer. An entity that is responsible for making the payment of a payment transaction.
(b) Receivers. An entity that has the right to receive a payment. This may be an entity who sells goods and services, or may be an individual person or other entity who has the need to receive payments (e.g. Business to Business “B2B”, Business to Consumer “B2C”, Consumer to Business “C2B”, Person to Person “P2P” transfers). The transaction exchange 100, although processing and storing transaction data for transactions with payer and receiver IDs does not need to maintain records for Payers or Receivers, unless an Account Keeper requires the transaction exchange 100 to do so on behalf of the Account Keeper (e.g. providing authorisation for a Payer when their Account Keeper service was offline) or unless a Payer or Receiver connects directly with a transaction exchange 100. A Payer and Receiver do not need to be registered or certified with the transaction exchange 100 unless they connect directly with the transaction exchange 100. The same entity is likely to be both a Payer and Receiver in the payments transaction system i.e. if a person has established themselves as a Payer their Account Keeper will generally enable them to also receive payments.
(c) Service Providers. An entity that provides services to Payers, Receivers or other participants of the payment system that enables, facilitates, or enhances the value of the payment transaction. Classes of Service Providers include: Guarantors; Identity Authenticators; Account Keepers; Payment Enabler Providers; Fund Managers/Fund Providers; Enhancement Service Providers; and Enhancement Service Processors. Service Providers that interact with a Transaction Exchange 100 (TX) are required to be registered with a transaction exchange. Account Keepers are registered and certified with a TX. Payment Enabler Providers and their associated Payment Enablers required to establish a connection with a TX can be registered and certified with a TX, e.g. Point of Sale devices (e.g. POS terminals), and Point of Purchase/Point of Payment (POP) services (e.g. internet payment gateways). For a Receiver or Payer to establish a connection with the TX at least one Payment Enabler needs to be registered and certified. Enhancement Service Providers and Enhancement Service Processors that require transaction data from the TX also need to be registered and certified.
(d) Guarantors. Service Providers that guarantee the payment risks a Payer or Receiver is required to be responsible for when other entities deal with them including settlement risk, fraud risk and credit risk. Guarantors are used to qualify Payers and Receivers to participate in the payment system or qualify transactions of an Account Keeper. The same Guarantor is likely to guarantee an entity both as a Payer and Receiver. For an individual person, the Fund Manager/Fund Provider or the Account Keeper is likely to act as the Guarantor. In the case of a Payer or Receiver being a merchant or trading entity the guarantee is more likely to be provided by a Guarantor that is independent of the Account Keeper or Fund Manager/Fund Provider.
(e) Identity Authenticators. Service Providers that obtain proof of identity from Payers and Receivers, and issue them with a certificate of identity that is used to gain access to other services linked to the payment system.
(f) Account Keepers (AK). Service Providers that create and manage the account which acts as origination or destination point for transactions. Account Keepers may provide basic account services without having an interest in the underlying financial aspects of the transactions, or they may provide both account keeping and be a deposit recipient and/or credit provider. An AK establishes an account on the server 151 for at least one Payer or at least one Receiver or both.
(g) Payment Enabler Providers (PEP). Service Providers that provide the physical or electronic infrastructure (including hardware, software and other services) i.e. Payment Enablers, that enables entities such as Payers/Receivers and Account Keepers to connect to other participants in the payment system. For Receivers these Payment Enablers may include POS terminal hardware and software 102, payment gateways on the Internet, and other communication equipment and interfaces. For Payers the Payment Enablers may include plastic cards, smart card chips and equipment 104, 106 for connecting to payment gateways and portals. However, a Payment Enabler for a Payer or a Receiver may be simply a username and password combination to provide online access to a payment gateway.
(h) Fund Managers, Fund Providers (FM/FP). Service Providers that provide a line of credit and/or savings/deposit or other facility attached to accounts managed by an Account Keeper. A Fund Manager typically provides a facility for an entity using funds of the entity, whereas a Fund Provider provides a facility for an entity using funds of their own or of a different entity. The Fund Managers/Fund Providers can collectively be referred to as Financial Facility Providers.
(i) Enhancement Service Providers (ESP). Service Providers that enhance the value of an individual payment transaction by delivering additional benefits (i.e. Enhancement Services) to either the Payer or Receiver who buys the service, or to the Receiver or Payer involved in exchanging payment with the ESP. Examples of Enhancement Services include product extended warranty, charge back rights, product related insurance (e.g. travel) credit provision (e.g. interest free days, extended payment terms, finance terms) and loyalty or reward programs. Receiver services would include services that they may benefit from directly (e.g. fraud protection), or indirectly if they pay for a transaction Enhancement Service that is offered to their customers (e.g. free credit period, reward program). Enhancement Service Providers may offer services to Payers and Receivers directly, or may act as wholesalers and choose to distribute via other participants (e.g. AK, FM/FP, Receiver). Enhancement Services may be offered individually or bundled together.
(j) Enhancement Service Processor (ESProcessor). Service Provider that identifies transactions that qualify for an Enhancement Service, and transmits the details of the transactions to the Enhancement Service Provider providing the service. An ESProcessor may also provide a service to register users of the Enhancement Service, calculate their service entitlements, and manage the service delivery. The role may be performed by equipment of a dedicated entity, or may be offered as additional service by AK, TX, FM/FP, Receiver or Enhancement Service Provider.
(k) Governance Body (GB). Responsible for governing the payment system. A governance process is determined in accordance with any applicable prudential/regulatory framework.

Services are registered with a TX if the TX 100 is required to play a role in the processing of the service. Entities may represent one or more of the Service Provider roles in the payment system e.g. Guarantors and Identity Authenticators may be the same entity or multiple entities working in partnership or independently. Payers and/or Receivers may choose to procure services as a bundle from one entity, or may acquire individual elements separately. Certification involves a service demonstrating that it conforms to standards set for the operation of the payment system (e.g. technical standards for hardware, software, and messages). Registration involves the TX providing unique identifiers that enable the origin and destination of transactions to be identified (e.g. each Account Keeper or EFTPOS terminal 102 has a unique identifier allocated to them).

The TX database 160 includes registration and entity records for: all the AKs; all the Guarantors and Identity Authenticators that interact with the TX; the Receivers, Payers or other Service Providers that connect directly to the TX; registered Payment Enablers; records of any stand-in authorities; and records and audit trail data of all transaction data processed by the TX.

To utilise and be a participant in the payment transaction system, each participant or party that connects directly to the TX performs a registration process (which may include a certification and identity authentication process) using their equipment 102 to 106 and 151 to 154 with the transaction exchange 100. This involves unique identifiers being allocated to entities, and registration and certification processes being performed, depending on the Service Provider type. The references to entities in the processes described below include a reference to the entity record included in the database 160 and also references to the computer processing equipment 102 to 106, 151 to 154 used by the entity to connect to the transaction exchange 100. The computer processing equipment 102 to 106, 151 to 154, in a number of instances, needs to be verified by the transaction exchange as meeting requirements for the payment transaction system. When required, software components are downloaded from the transaction exchange 100 to the processing equipment of the entities. The format of, and the significant data elements included in, the communications messages (data packets) passed between the transaction exchange 100 and the equipment is recited in the accompanying Appendix. The transaction exchange includes a message processor 1000 which processes all of the communication messages to determine if they are valid messages of the payment transaction system, based on the data stored in the database 160 and the format and data values required for the messages, as discussed below and in the Appendix.

The components of the transaction exchange 100 and the systems 108 to 120 used to perform the processes described below may be provided using a number of different hardware and software architectures. For example, software components (having computer program instruction code written in computer languages such as C# or VB.Net) based on the Microsoft.Net architecture or framework (http://www.msdn.microsoft.com/netframework/) may be used and stored on computer readable storage media (e.g. hard disks 160) of the servers 150 to 154. Alternatively, the messages may be processed by dedicated hardware components, such as Application Specific Integrated Circuits (ASICs) or Field Programmable Gate Arrays (FPGAs).

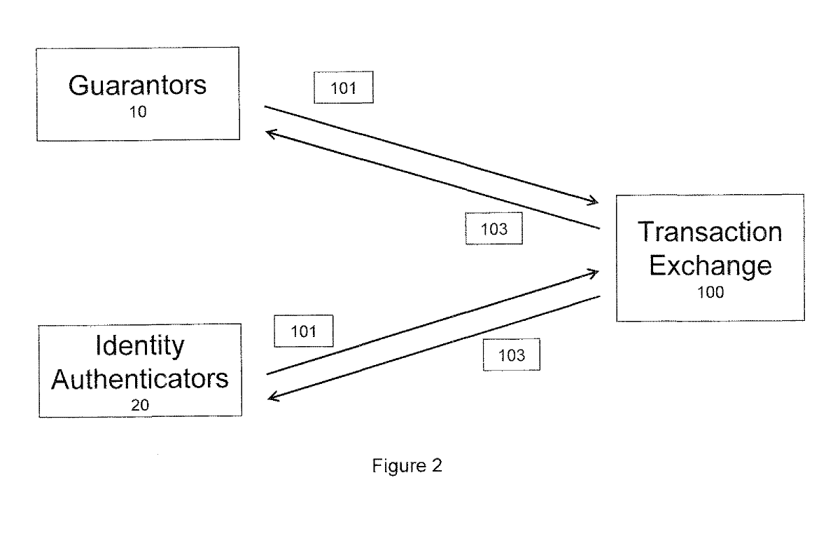

Guarantors 10 and Identity Authenticators 20, as shown in FIG. 2, apply for registration by sending a registration application message 101 that includes an application ID and other details required for assessment. The transaction exchange is able to assess those applications on the basis of a number of criteria including financial, technical, security and regulatory criteria. On approval of an application, the transaction exchange allocates a unique identifier, a registration ID, and a registration message 103 is issued to the Guarantor and Identity Authenticator.

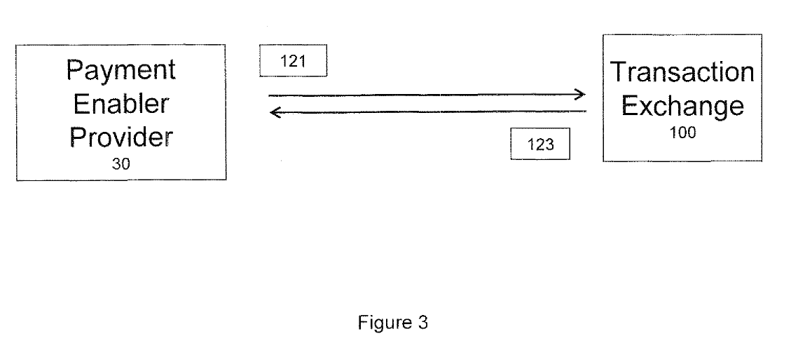

A Payment Enabler Provider 30, as shown in FIG. 3, needs to have their equipment certified and registered with a transaction exchange 100 so that the equipment, such as a payment terminal 102 can operate as a payment transaction origination point. The Payment Enabler Provider 30 applies for registration and certification in a message 121 that includes a number of data elements representing an application ID, a Payment Enabler Provider ID and data concerning aspects of the equipment, such as operating system, application software, security protocols etc. The transaction exchange 100 performs a certification process to ensure that data provided meets criteria for a payment terminal and then issues a certification message 123 including a registration ID, an ID for the Payment Enabler Provider entity, and ID's and certification numbers for the actual payment enabler e.g. payment terminals 102 or cards.

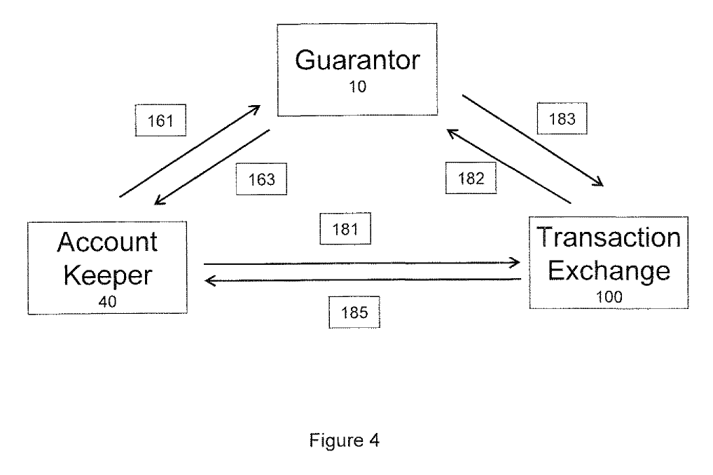

An Account Keeper 40, as shown in FIG. 4, is also able to apply for registration and certification with the transaction exchange 100. An Account Keeper 40, however, must first be associated with a Guarantor 10. The Guarantor 10 issues a guarantee to the Account Keeper 40 to cover payment or any other risks associated with the Account Keeper operating with the transaction exchange 100. The Account Keeper 40 forwards an application message 161 to apply for a guarantor service, and the Guarantor 10 is able to issue a guarantee message 163 that includes a guarantee limit and expiry date. The Account Keeper 40 on obtaining the guarantee is then able to apply for registration and certification in a message 181 with the transaction exchange 100. The message 181 includes data elements related to the guarantee and application details for the Account Keeper. The transaction exchange 100 processes the data elements and forwards details concerning the Account Keeper and the guarantee to the Guarantor 10 in a confirmation request message 182. The transaction exchange 100 must receive from the Guarantor 10 a confirmation message 183 confirming the guarantee associated with the Account Keeper 40 for the process to complete. The transaction exchange 100 can then issue a certification message 185 to the Account Keeper 40 that includes the unique registration ID, provided all certification criteria are met. The criteria include, in addition to the guarantee, technical and communication message interface standards to be met between the transaction exchange 100 and the Account Keeper 40.

Similar registration and certification processes are performed for other types of Service Provider entities, such as Enhancement Service Providers, that wish to transact with the transaction exchange 100. Depending on the transactions that are to be performed by the Service Provider entity, the transaction exchange 100 may require provision of a guarantee from an associated Guarantor 10.

To utilise the transaction exchange 100, a Payer 50 needs to obtain an associated Account Keeper service from an Account Keeper 40 that is registered with the transaction exchange 100. The Account Keeper 40 needs to manage settlement risk, Payer fraud and identify fraud that may be associated with a Payer. Payers will therefore normally only be accepted after obtaining a valid identity token from an Identity Authenticator 20. The Account Keeper 40 may also require a guarantee to be issued by a Guarantor 10. A Payer 50 is able to directly apply to a registered Identity Authenticator 20 in an application message 201, so as to obtain an identity token in a message 203, which includes a Payer ID, a token ID, an identity token issue date and expiry date. The criteria utilised by the Identity Authenticator would normally be established by law in each jurisdiction or set by operators of the transaction exchange 100. Examples include the 100 point identity check mandated in Australia for financial transactions. The Payer can then apply in an application message 206 for an Account Keeper service with an Account Keeper 40. The message 206 includes the identity token and other Payer identification details. The Account Keeper 40 then sends an identity confirmation message 207 to the Identity Authenticator 20. To complete the process, the Account Keeper 40 requires confirmation from the Identity Authenticator in a message 208 that confirms the identity token. The message 208 includes an identity token confirmation ID. The Account Keeper 40 can then forward a service confirmation message 210 that advises a Payer of account numbers associated with established accounts, and other details associated with accounts maintained by the Account Keeper 40, such as account open dates and renewal dates.

For Payers, an Account Keeper 40 may require a Fund Manager/Fund Provider to act as the Guarantor 10. The Fund Manager/Fund Provider may represent the settlement risk, as an association with a Payer can make them responsible for any fraud or credit risk associated with the Payer.

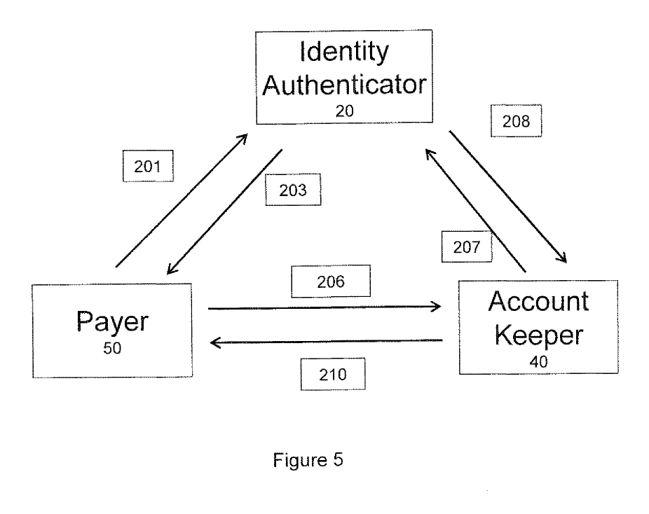

The process described above, with reference to FIG. 5, for Payers can equally apply for a Receiver.

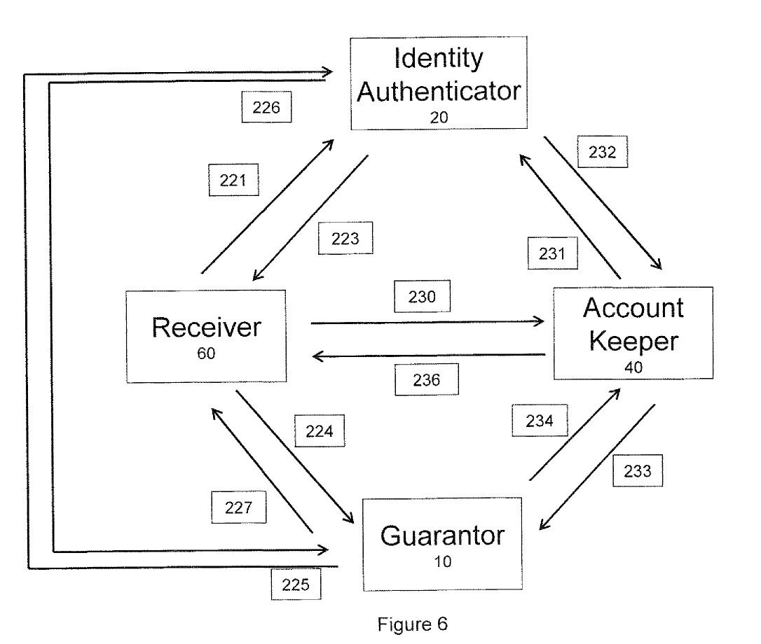

For a Receiver to establish an Account Keeper service with an Account Keeper the process is similar to that as described above for a Payer, but more rigorous for certain Receivers such as those Receivers acting as merchants supplying products and services, as shown in FIG. 6. The Account Keeper 40 needs to manage risks including Receiver fraud and identify fraud that may be associated with a Receiver. A Receiver 60 would need to issue messages to obtain both an identity token from an Identity Authenticator 20, and a guarantee in a message 227 from a Guarantor 10. The Guarantor 10 requests in a message 225 a confirmation concerning the Receiver identity token and the Identity Authenticator 20 may provide that confirmation in a message 226. Once the identity token and guarantee are obtained, the Receiver is able to forward details of the identity token and the guarantee in an application message 230 to a certified Account Keeper 40. The Account Keeper 40 then needs to obtain confirmation concerning the identity token and the guarantee, and on obtaining confirmation ID's can confirm the service. The confirmation message 236 advises the Receiver concerning the account numbers and other details associated with the service.

The processes described above, with reference to FIG. 6, for Receivers can equally apply for a Payer.

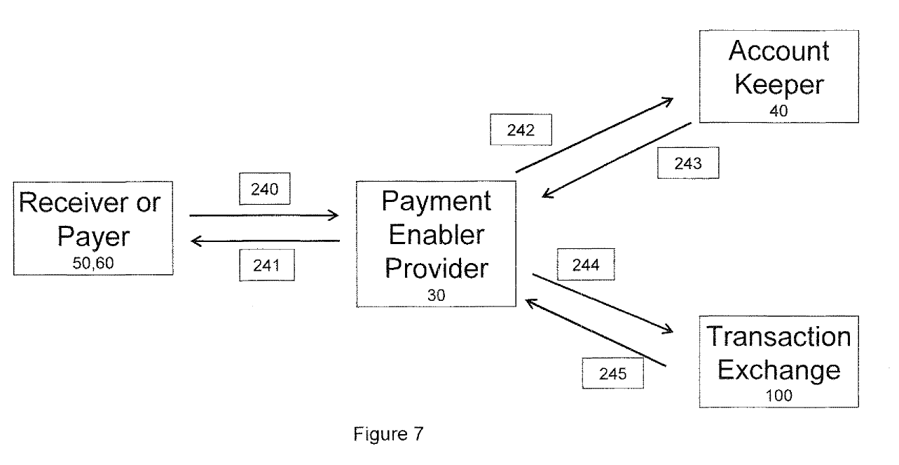

Payers and Receivers 50, 60 are able to apply, as shown in FIG. 7, for a payment enabler from a Payment Enabler Provider 30. For Payers, the payment enabler includes credit and charge cards and PINS that enable a Payer 50 to use EFT networks at a point of sale, or user names and passwords to enable online access. The payment enablers used by a Receiver may include payment terminals 102 and Internet payment gateways that are part of the communications network 140. The Payer or Receiver forwards an application message 240 to a Payment Enabler Provider 30, as shown in FIG. 7, which includes details concerning the account associated with Account Keeper 40 and any associated account numbers. The Payment Enabler Provider 30 is able to issue a payment enabler and the associated ID numbers and any other specific data associated with the enabler is sent in a message 241. Data concerning the issued payment enablers is then subsequently registered with the associated Account Keeper 40. If the payment enabler is used to connect with the transaction exchange 100, it is also registered with the transaction exchange 100.

Payers and Receivers 50, 60 are able to apply in an application message 261 for services from Fund Managers and Fund Providers 70 in order to provide funds that can then be associated with the accounts maintained by the Account Keeper 40. The application message 261 therefore includes data concerning the Account Keeper ID and details concerning the account numbers etc. maintained by the Account Keeper 40. Data associated with the terms of a facility and confirmation concerning data is provided back in a facility message 263 to the Receiver or Payer if successful. The Fund Manager/Fund Provider 70 is then able to register the facility with the Account Keeper 40. The Fund Manager/Fund Provider may be the same entity as the Account Keeper, but the Account Keeper 40 may be an entirely separate entity and provide access to a number of different Fund Managers/Fund Providers. Once the facility is obtained and registered, the Fund Manager/Fund Provider 70 is responsible for payment which is associated with a Payer. A Fund Manager/Fund Provider 70 and Account Keeper 40 may also operate as a Guarantor 10. Once a facility is registered with the Account Keeper 40, confirmation of registration is advised in messages 265 and 266 to the Receiver/Payer and the Fund Manager/Fund Provider. Data stored by the Account Keeper 40 includes facility ID, facility limits, access tokens such as passwords, and expiry dates.

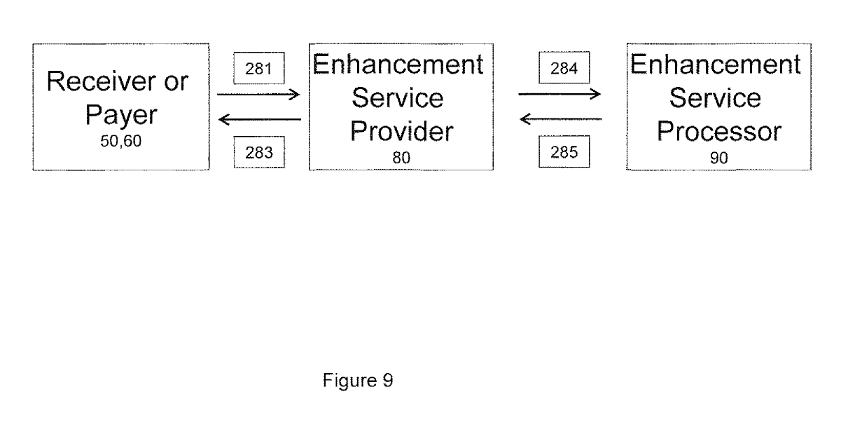

A Receiver or Payer is able to request an enhancement service from an Enhancement Service Provider, as shown in FIG. 9. Enhancement services include extended product warranty, free credit period, loyalty programs etc., that can be associated with a payment transaction. To request the service, an Account Keeper ID needs to be provided, together with an account number that will be used with the service, in a request message 281. The Enhancement Service Provider 80 then issues terms of the service at a message 283. Once the service has been established, the provider 80 registers the service with an Enhancement Service Processor 90 that will act to identify when qualification criteria of the service are met for a transaction. The Enhancement Service Processor 90 processes the transactions to ensure provision of the enhancement service for the Payer or Receiver. This role may be performed by the transaction exchange 100, Account Keeper 40, Fund Manager/Fund Provider 70, Enhancement Service Provider 80, or an entirely separate Enhancement Service Processor 90 e.g. an independent server.

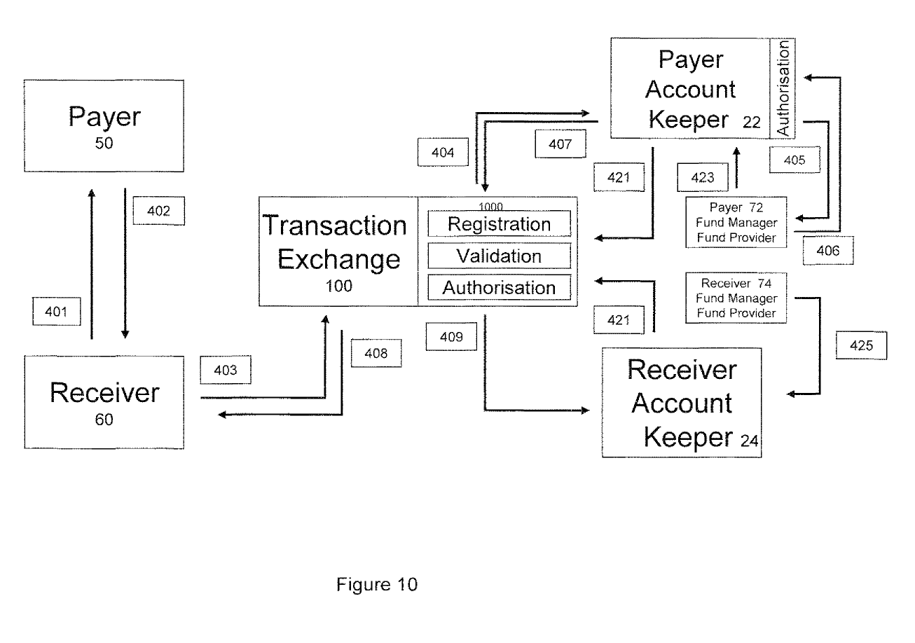

A Receiver 60, as shown in FIG. 10, is able to initiate a payment transaction, and typically these transactions would be initiated at a point of sale or a point of purchase, such as on the Internet, where payment is processed at the time of purchase. The transaction exchange 100 processes messages from the Receiver 60 and communicates with the Payer Account Keeper 22 to obtain payment authorisation. Once authorisation is obtained from the Payer Account Keeper 22, the transaction exchange 100 advises the Receiver Account Keeper 24, and then processes settlement messages between the Account Keepers 22, 24. The Receiver 60 requests payment particulars in a message 401. The Payer 50 provides payment particulars in a message 402 that includes the Payer identity token, such as a PIN, card ID (if used) Account Keeper ID and the account number of the facility to be debited that is associated with the Payer Account Keeper 22. The Receiver sends the payment data associated with the transaction in a message 403 to the transaction exchange 100. This includes a transaction ID and data associated with the Receiver, such as the Receiver ID, Receiver Account Keeper ID, and the account number of the account to be credited associated with the Receiver Account Keeper 24. The transaction exchange 100 processes the message to determine if the message 403 includes a valid payment transaction, i.e. the transaction data includes the correct data fields and values and, in particular, the correct ID data, based on that held in the database 160. The transaction data is forwarded to the Payer Account Keeper 22 in a message 404 to obtain authorisation. Alternatively, authorisations can be provided directly by the transaction exchange 100, based on parameters associated with the Payer Account Keeper 22. If the transaction exceeds the Payer Account Keeper authority, the Payer Account Keeper 22 may need to seek authorisation authority in a message 405 to the associated Fund Manager/Fund Provider 72. The Fund Manager/Fund Provider may provide an authorisation response 406. The Payer Account Keeper 22 forwards an authorisation response 407 to the transaction exchange 100. The authorisation response includes the transaction ID and the Payer ID. The payment transaction data is sent by the transaction exchange 100 with the authorisation response to the Receiver Account Keeper in a transaction approved message 409. The authorisation response is sent in a message 408 from the transaction exchange 100 to the Receiver 60. The Account Keepers 22, 24 adjust the accounts on the basis of the authorisation response and settlement messages 421 are issued and maintained by the transaction exchange 100. The settlement messages include data concerning the settlement positions of the individual respective Account Keepers 22, 24. For any accounts adjusted by the Fund Manager/Fund Provider 72, 74 settlement messages 423 and 425 are sent to the Account Keepers 22, 24 and the settlement data persisted.

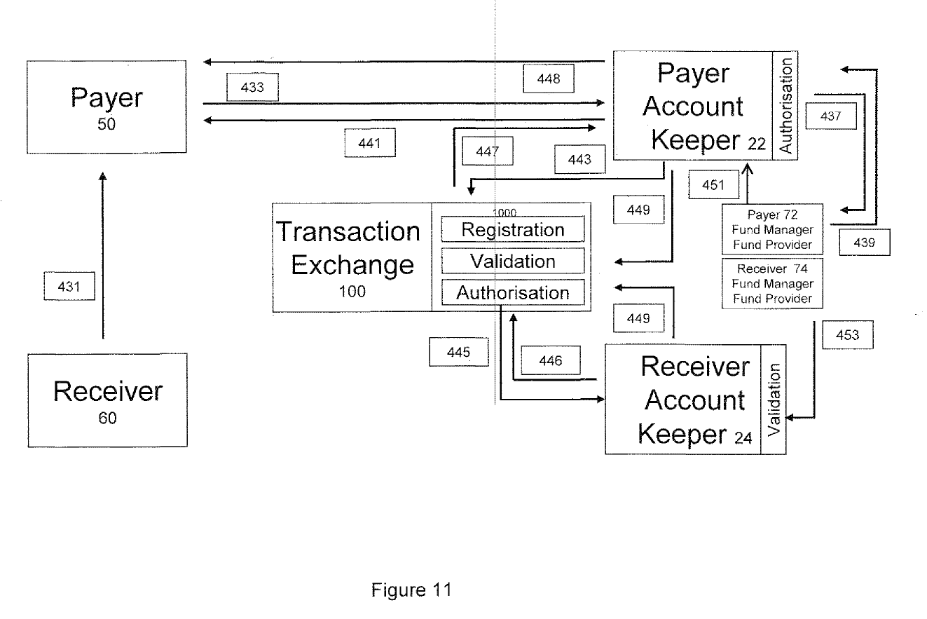

A Payer is also able to initiate a payment transaction, as shown in FIG. 11. This may occur where the Receiver 60 issues a request for payment, for example by issuing a physical or electronic statement, bill or invoice, or provides payment/account details in the instance of a gift or donation being promised. In this instance, the Payer 50 determines when and how the payment will occur. The Receiver 60 can issue a payment demand message 431 that will include an ID for the transaction. The Payer 50 can issue a message 433 to the Payer Account Keeper 22 to initiate and make the payment associated with the transaction. The data included in the message includes identifying data associated with any statement, bill or invoice, details concerning the transaction amount, and identifying data, such as that associated with payment enablers, the Payer ID, and Receiver Account Keeper ID and the account to be credited as provided by the Receiver. The Payer Account Keeper ID is also to be included, together with the account number of the facility to be debited. If the transaction exceeds the Payer Account Keeper authority, authorisation may be sought in a message 437 from the Payer Fund Manager/Fund Provider 72 and the Fund Manager/Fund Provider may provide an authorisation response 439. Ultimately, once authorisation is obtained, the Payer Account Keeper 22 generates an authorisation response message 441 to the Payer 50 that includes transaction ID and the authorisation response. The Payer Account Keeper 22 then sends a payment transaction message 443 to the transaction exchange 100 that includes all data concerning the transaction, together with the authorisation response. The transaction exchange 100 determines the validity of the transaction data of the payment transaction message 443, which includes comparing the ID data in the message to that held in the database 160. The transaction exchange 100 generates and sends a payment transaction message 445 to the identified Receiver Account Keeper 24 and includes the authorisation response and advises the Receiver account number of the facility to be credited. The Receiver Account Keeper 24 validates the Receiver account data, and issues a confirmation message 446 to the transaction exchange 100 that the payment has been successfully posted to the Receiver's account. The transaction exchange 100 sends a confirmation message 447 to the Payer Account Keeper 22. The Payer Account Keeper 22 sends a confirmation message 448 to the Payer 50. The Account Keepers 22 and 24 adjust the identified accounts and on doing so issue settlement messages 449 to the transaction exchange. Depending on the authorisation and validation performed, the Payer and Receiver Fund Managers/Fund Providers 72, 74 may also issue respective settlement messages 451 and 453 to the Account Keepers 22 and 24.

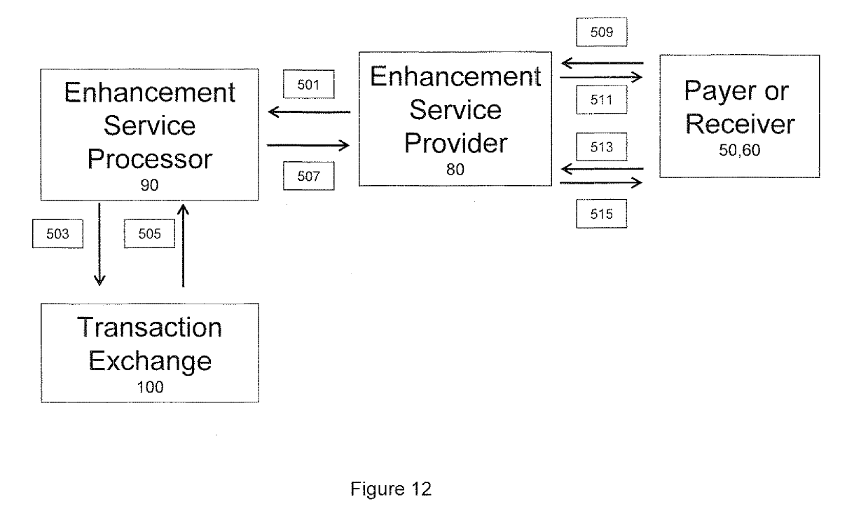

For enhancement service delivery, as shown in FIG. 12, the Enhancement Service Provider 80 establishes the qualification criteria that determines which payment transactions trigger an enhancement service. The qualification criteria may include the nature of the transaction (amount, date of transaction etc), type of good or service purchased (e.g. using SKU number (i.e. Stock Keeping Unit number), EAN number (ie. European Article Numbering Code) or UPC (Universal Product Code)), transactions generated by a class of Payer, for example the Payers of a particular Account Keeper or Fund Manager/Fund Provider, or other criteria associated with data processed by the transaction exchange 100. The qualification criteria data is sent in message 501 to a registered Enhancement Service Processor 90. In turn this data is sent in message 503 to the transaction exchange 100. The transaction exchange 100 monitors the transactions to determine when the qualification criteria are met and then passes transaction data associated with qualifying payment transactions to the Enhancement Service Processor 90 in a message 505. The Enhancement Service Processor 90 determines the value of the service accrued for each particular service type from the transactions and the value data is provided in a message 507 to the Enhancement Service Provider 80. A Payer or Receiver 50, 60 is then able to issue a request 509 to obtain details of the qualifying payment transactions and the value of any service accrued from the Enhancement Service Provider 80 is included in a message 511. A Payer or Receiver 50, 60 is also able to request delivery of the service in a request message 513 to the Enhancement Service Provider 80. The manner in which the enhancement service is delivered would depend on the type of the service. Delivery may be automated e.g. discounts or reward program points determinations, or may need to be obtained by a request, e.g. extended product warranties, travel insurance claims or charge back rights. Delivery or confirmation of delivery can be provided in a message 515.

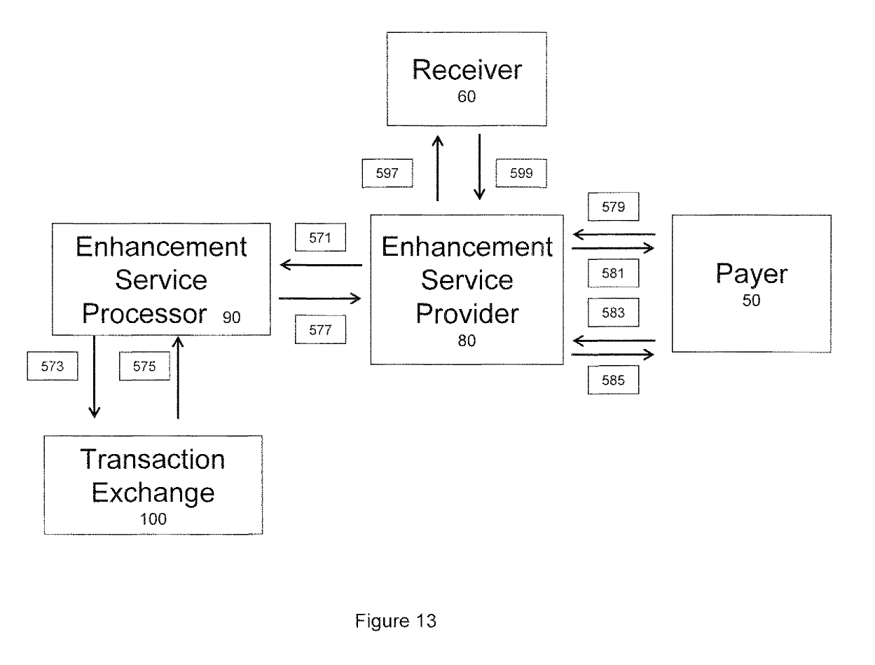

For enhancement services acquired by a Receiver and provided to Payers, as shown in FIG. 13, the messages exchanged between the Enhancement Service Provider 80, the Enhancement Service Processor 90 and the transaction exchange 100 to establish the qualification criteria and identify qualifying payment transaction is similar to that described above, except the qualification criteria includes data concerning the Payers and Receivers that are registered for the service. The enhancement services that may be payed for by a Receiver include an extended product warrantee or a concessional interest rate for goods bought on credit where the retailers may subsidise the interest rate charged to the consumer. The Enhancement Service Processor 90 processes the qualifying payment transactions and determines the services that have been accrued by the Payers, and also determines the total value of the services payable by the Receiver. The accrual is advised in a message 577 to the Enhancement Service Provider 80. A Payer 50 can again request details of qualifying transactions and value of service in a message 579, and can also request service delivery in a message 583. The Enhancement Service Provider advises receipt of the value of the services accrued and services delivered to Payers in a message 597 and the Receiver 60 settles with the Enhancement Service Provider 80 using a settlement message 599.

The payment transaction system is particularly advantageous as it:
(a) Reduces the cost of payment processing by eliminating interchange payments paid between merchants and card issuers. The payment transaction system enables Payers and Receivers to initiate and complete payment transactions using the transaction exchange 100 without incurring additional fees, other than those directly imposed by the Service Providers of their choice, whilst not requiring any exchange of fees between Account Keepers for transactions.
(b) Reduces the cost of payment processing by standardising transaction processing. The payment transaction system does not differentiate transaction processing according to the type of account to which the transaction will be posted.
(c) Provides merchants and consumers with greater choice as to which value added elements they wish to pay for and have associated with their transactions. The payment transaction system allows for one or more enhancement services to be attached to a transaction independently from the processing of the underlying transaction. Payers and Receivers can purchase individual enhancement services separately and from separate providers rather than as a “bundle” associated with a particular payment scheme
(d) Reduces barriers to entry for new payment services, new card issuers, new account providers, and new merchants. The payment transaction system provides any Enhancement Service Provider, Account Keeper, or Receiver that conforms to the system standards the ability to connect to the transaction exchange 100 (either directly and/or via their Account Keeper) and offer their services to any Payer or Receiver that is also connected to the system, without having to build their own system of connections to Payers, Receivers, or Account Keepers.
(e) Reduces the cost of payment processing for Payers and Receivers by standardising transaction processing. A Payer or Receiver of a payment only needs one connection to the transaction exchange 100 to transact payments with any different payment schemes, offerings or systems that are registered with the transaction exchange 100.
(f) Provides merchants and consumers with greater choice and flexibility as to how they link payment transactions with financial service facilities. The payment transaction system allows for the Account Keeper to be separate from the Fund Manager or Fund Provider, so that the Account Keeper does not need to provide credit or debit facilities directly but can enter a separate association with one or more Fund Managers or Fund Providers.

Many modifications will be apparent to those skilled in the art without departing from the scope of the present invention as hereinbefore described with reference to the accompanying drawings.

### APPENDIX

FIG. 2

| Messages | Description | Data Elements |
|---|---|---|
| 101 | Guarantor or Identity | Guarantor or Identity Authenticator |
| | Authenticator applies | Application ID number |
| | for registration | Applicant type |
| | | Application Date |
| | | Applicant specific data eg Company |
| | | name, Address, Key Officers, |
| | | Contact details, Company financials |
| 103 | Issue registration | Guarantor or Identity Authenticator |
| | | Application ID number |
| | | Registration ID number |
| | | Registration date |
| | | Registration expiry date |

FIG. 3

| Message | Description | Data Elements |
|---|---|---|
| 121 | Provider of Payment | Payment Enabler Application |
| | Enablers applies for | ID number |
| | registration and | Applicant type |
| | certification with TX | Application Date |
| | | Payment Enabler Provider ID number |
| | | Payment Enabler specific data eg |
| | | Operating system, application |
| | | software, security protocols |
| 123 | TX issues certification | Payment Enabler Application |
| | | ID number |
| | | Registration ID number |
| | | Payment Enabler Provider ID number |
| | | Payment Enabler ID number |
| | | Certification Number |
| | | Certification date |
| | | Certification expiry date |

FIG. 4

| Message | Description | Data Elements |
|---|---|---|
| 161 | Account Keeper | Account Keeper Application ID number |
| | applies for | Applicant type |
| | Guarantor service | Application Date |
| | | Account Keeper ID number |
| | | Account Keeper specific data eg |
| | | Company name, Address, Key Officers, |
| | | Contact details, Company financials |
| 163 | Guarantor issues | Account Keeper Application ID number |
| | guarantee | Guarantor ID number |
| | | Guarantee ID number |
| | | Account Keeper ID number |
| | | Guarantee date |
| | | Guarantee limit |
| | | Guarantee expiry date |
| 181 | Account Keeper | Account Keeper Application ID number |
| | applies for | Applicant type |
| | registration and | Application Date |
| | certification | Account Keeper ID number |
| | with TX | Account Keeper specific data eg |
| | | Company name, Address, Key Officers, |
| | | Contact details |
| | | Guarantor ID number |
| | | Guarantee ID number |
| | | Guarantee date |
| | | Guarantee limit |
| | | Guarantee expiry date |
| 182 | TX requests | Account Keeper ID number |
| | confirmation of | Guarantor ID number |
| | guarantee with | Guarantee ID number |
| | Guarantor | Guarantee date |
| | | Guarantee limit |
| | | Guarantee expiry date |
| 183 | Guarantor | Account Keeper ID number |
| | confirms | Guarantor ID number |
| | guarantee | Guarantee ID number |
| | to TX | Guarantee confirmation ID number |
| 185 | TX Issues | Account Keeper Application ID |
| | certification | Account Keeper ID number |
| | | Unique registration ID |
| | | Certification Number |
| | | Certification date |
| | | Certification expiry date |

FIG. 5

| Message | Description | Data Elements |
|---|---|---|
| 201 | Payers apply to Identity | Payers Application ID number |
| | Authenticator for | Applicant type |
| | Identity Token | Application Date |
| | | Payer specific data eg Name, |
| | | Address, Contact details, identity |
| | | documents (eg passport, |
| | | citizenship certificate, drivers |
| | | licence, utility bill, referee details) |
| 203 | Identity Authenticator | Payers Application ID number |
| | issues Identity Token | Identity Authenticator ID number |
| | | Payer ID number |
| | | Identity Token ID number |
| | | Identity Token issue date |
| | | Identity Token expiry date |
| 206 | Payer applies for | Payers Application ID number |
| | Account Keeper Service | Applicant type |
| | | Application Date |
| | | Payer ID number |
| | | Payer specific data eg Name, |
| | | Address, Contact details |
| | | Identity Authenticator ID number |
| | | Identity Token ID number |
| | | Identity Token issue date |
| | | Identity Token expiry date |
| 207 | Account Keeper requests | Payer ID number |
| | confirmation of Identity | Identity Authenticator ID number |
| | Token with Identity | Identity Token ID number |
| | Authenticator | Identity Token issue date |
| | | Identity Token expiry date |
| 208 | Identity Authenticator | Payer ID number |
| | confirms Identity Token | Identity Authenticator ID number |
| | to Account Keeper | Identity Token number |
| | | Identity Token confirmation ID |
| | | number |
| 210 | Account Keeper | Payers Application ID |
| | confirms service | Payer ID number |
| | | Account Keeper ID number |
| | | Payer Account Number (and |
| | | sub-account numbers) |
| | | Account open date |
| | | Account renewal date |

FIG. 6:

| Message | Description | Data Elements |
|---|---|---|
| 221 | Receivers apply to | Receiver Application ID number |
| | Identity Authenticator | Applicant type |
| | for Identity Token | Application Date |
| | | Receiver specific data eg Company |
| | | name, Address, Key Officers, |
| | | Contact details, |
| | | Referees (eg bankers, auditors, |
| | | accountants) |
| 223 | Identity Authenticator | Receiver Application ID number |
| | issues Identity Token | Identity Authenticator ID number |
| | | Receiver ID number |
| | | Identity Token ID number |
| | | Identity Token issue date |
| | | Identity Token expiry date |
| 224 | Receiver applies for | Receiver Application ID number |
| | Guarantor service | Applicant type |
| | | Application Date |
| | | Receiver ID number |
| | | Identity Authenticator ID number |
| | | Identity Token ID number |
| | | Identity Token issue date |
| | | Identity Token expiry date |
| | | Receiver specific data eg for |
| | | businesses this would include: |
| | | Company name, Address, |
| | | Key Officers, Contact details, |
| | | Company financials |
| 225 | Guarantor requests | Guarantor ID number |
| | confirmation of Identity | Receiver ID number |
| | Token with Identity | Identity Authenticator ID number |
| | Authenticator | Identity Token ID number |
| | | Identity Token issue date |
| | | Identity Token expiry date |
| 226 | Identity Authenticator | Receiver ID number |
| | confirms Identity Token | Guarantor ID number |
| | to Guarantor | Identity Authenticator number |
| | | Identity Token number |
| | | Identity Token confirmation ID |
| | | number |
| 227 | Guarantor issues | Receiver Application ID number |
| | guarantee | Guarantor ID number |
| | | Guarantee ID number |
| | | Guarantee date |
| | | Guarantee limit |
| | | Guarantee expiry date |
| 230 | Receiver applies for | Receiver Application ID number |
| | Account Keeper Service | Applicant type |
| | | Application Date |
| | | Receiver ID number |
| | | Receiver specific data eg Name, |
| | | Address, |
| | | Contact details |
| | | Identity Authenticator ID number |
| | | Identity Token ID number |
| | | Identity Token issue date |
| | | Identity Token expiry date |
| | | Guarantor ID number |
| | | Guarantee ID number |
| | | Guarantee date |
| | | Guarantee limit |
| | | Guarantee expiry date |
| 231 | Account Keeper | Account Keeper ID number |
| | requests confirmation of | Receiver ID number |
| | Identity Token with | Identity Authenticator ID number |
| | Identity Authenticator | Identity Token ID number |
| | | Identity Token issue date |
| | | Identity Token expiry date |
| 232 | Identity Authenticator | Receiver ID number |
| | confirms Identity Token | Account Keeper ID number |
| | to Account Keeper | Identity Authenticator number |
| | | Identity Token number |
| | | Identity Token confirmation ID |
| | | number |
| 233 | Account Keeper | Account Keeper ID number |
| | requests confirmation of | Receiver ID number |
| | guarantee with | Guarantor ID number |
| | Guarantor | Guarantee ID number |
| | | Guarantee date |
| | | Guarantee limit |
| | | Guarantee expiry date |
| 234 | Guarantor confirms | Account Keeper ID number |
| | guarantee to Account | Receiver ID number |
| | Keeper | Guarantor ID number |
| | | Guarantee ID number |
| | | Guarantee confirmation ID number |
| 236 | Account Keeper | Receiver Application ID |
| | confirms service | Receiver ID number |
| | | Account Keeper ID number |
| | | Receiver Account Number (and |
| | | sub-account numbers) |
| | | Account open date |
| | | Account renewal date |

FIG. 7:

| Message | Description | Data Elements |
|---|---|---|
| 240 | Payer/Receivers requests | Payer/Receiver Application |
| | service from Payment | ID number |
| | Enabler Provider | Application Date |
| | | Payer/Receiver ID number |
| | | Account Keeper ID number |
| | | Payer/Receiver Account Number at |
| | | Account Keeper |
| | | Enabler type(s) requested |
| | | Number of enablers of each |
| | | type required |
| 241 | Payment Enabler | Payer/Receiver Application |
| | Provider delivers | ID number |
| | Payment Enabler | Application Date |
| | | Payer/Receiver ID number |
| | | Payment Enabler Provider ID |
| | | number |
| | | Payment Enabler ID number(s) |
| | | Payment Enabler specific data |
| 242 | Payment Enabler | Payer/Receiver Application |
| | Provider registers | ID number |
| | Payment Enablers with | Payer/Receiver ID number |
| | Account Keeper | Account Keeper ID number |
| | | Payer/Receiver Account Number at |
| | | Account Keeper |
| | | Payment Enabler Provider ID |
| | | number |
| | | Payment Enabler ID number(s) |
| | | Payment Enabler specific data |
| 243 | Account Keeper | Payer/Receiver Application |
| | confirms registration | ID number |
| | | Account Keeper ID number |
| | | Payer/Receiver ID number |
| | | Payer/Receiver Account Number at |
| | | Account Keeper |
| | | Registration ID number |
| | | Registration date |
| | | Registration expiry date |
| 244 | Payment Enabler | Application ID number |
| | Provider registers | Payer/Receiver ID number |
| | Payment Enablers with | Account Keeper ID number |
| | TX | Payer/Receiver Account Number at |
| | | Account Keeper |
| | | Payment Enabler Provider |
| | | ID number |
| | | Payment Enabler ID number(s) |
| | | Payment Enabler specific data |
| 245 | TX confirms registration | Payer/Receiver Application |
| | to Payment Enabler | ID number |
| | Provider | Payer/Receiver ID number |
| | | Account Keeper ID number |
| | | Payer/Receiver Account Number at |
| | | Account Keeper |
| | | Payment Enabler Provider ID |
| | | number |
| | | Payment Enabler ID number(s) |
| | | Registration ID number |
| | | Registration date |
| | | Registration expiry date |

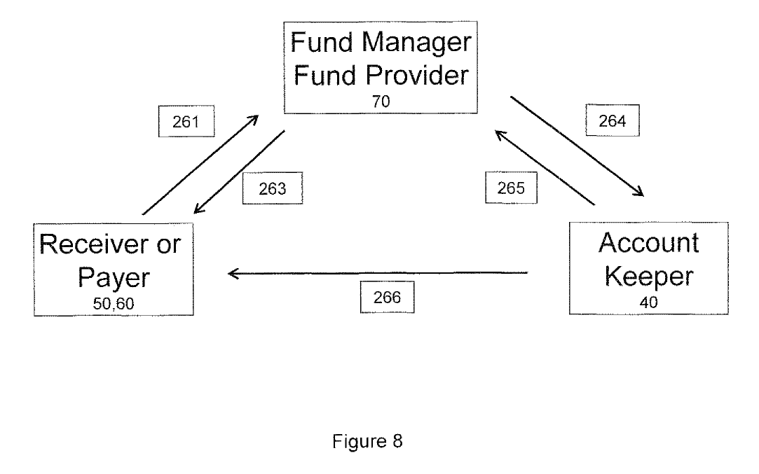

FIG. 8

| Message | Description | Data Elements |
|---|---|---|
| 261 | Payers/Receiver apply to | Application ID number |
| | Fund Manager/Fund | Applicant type |
| | Providers for services | Application Date |
| | | Payer/Receiver specific data |
| | | required by FM/FP |
| | | Identity Authenticator ID number |
| | | Identity Token ID number |
| | | Payer/Receiver ID number |
| | | Account Keeper ID number |
| | | Payer/Receiver Account Number at |
| | | Account Keeper |
| | | Receivers only |
| | | Guarantor ID number |
| | | Guarantee ID number |
| | | Guarantee date |
| | | Guarantee limit |
| | | Guarantee expiry date |
| 263 | Fund Manager/Fund | Application ID number |
| | Providers issues terms of | Payer/Receiver ID number |
| | facility to | Fund Manager/Fund Providers |
| | Payer/Receiver | ID number |
| | | Facility ID number |
| | | Facility limits (eg credit line, |
| | | individual transaction $ limits, |
| | | daily $ transfers limits) |
| | | Facility access tokens |
| | | (eg passwords) |
| | | Facility expiry date |
| | | Account Keeper ID number |
| | | Payer/Receiver Account Number at |
| | | Account Keeper |
| 264 | Fund Manager/Fund | Payer/Receiver ID number |
| | Providers registers | Fund Manager/Fund Providers |
| | facility with | ID number |
| | Payer/Receiver Account | Facility ID number |
| | Keeper | Facility limits (eg credit line, |
| | | individual |
| | | transaction $ limits, daily $ |
| | | transfers limits) |
| | | Facility access tokens |
| | | (eg passwords) |
| | | Facility expiry date |
| | | Account Keeper ID number |
| | | Payer/Receiver Account Number at |
| | | Account Keeper |
| 265 | Account Keeper | Account Keeper ID number |
| | confirms registration | Payer/Receiver ID number |
| | with Fund | Payer/Receiver Account Number at |
| | Manager/Fund Providers | Account Keeper |
| | | Payer/Receiver sub-Account |
| | | Number that will be used at |
| | | Account Keeper |
| | | Fund Manager/Fund Providers |
| | | ID number |
| | | Facility ID number |
| | | Facility ID confirmation number |
| 266 | Account Keeper | Account Keeper ID number |
| | confirms registration | Payer/Receiver ID number |
| | with Payer/Receiver | Payer/Receiver Account Number at |
| | | Account Keeper |
| | | Payer/Receiver sub-Account |
| | | Number that will be used at |
| | | Account Keeper |
| | | Fund Manager/Fund Providers |
| | | ID number |
| | | Facility ID number |
| | | Facility ID confirmation number |

FIG. 9

| Mes- | | |
|---|---|---|
| sage | Description | Data Elements |
| 281 | Payers/Receivers request | Payer/Receiver Application ID number |
| | enhancement service | Applicant type |
| | from Enhancement | Application Date |
| | Service Providers | Payer/Receiver specific data required by |
| | (request may be made | Enhancement Service Providers |
| | via Account Keeper, | Payer/Receiver ID number |
| | Fund Manager/Fund | Account Keeper ID number |
| | Provider or TX acting as | Payer/Receiver Account Number/sub- |
| | agent of Enhancement | Account number at Account Keeper that |
| | Service Providers) | will be using service |
| 283 | Enhancement Service | Payer/Receiver Application ID number |
| | Provider issues terms of | Payer/Receiver ID number |
| | Enhancement Service to | Enhancement Service Provider ID |
| | Payer/Receiver | Enhancement Service ID number |
| | | Enhancement Service limits or |
| | | qualification criteria (eg individual |
| | | transaction limits, daily limits, annual |
| | | limits, time or place of transaction) |
| | | Enhancement Service expiry date |
| | | Account Keeper ID number |
| | | Payer/Receiver Account Number/sub- |
| | | Account number at Account Keeper that |
| | | will be using service |
| 284 | Enhancement Service | Payer/Receiver ID number |
| | Provider registers | Enhancement Service Provider ID |
| | service with | Enhancement Service ID number |
| | Enhancement Service | Enhancement Service limits or |
| | Processor (Enhancement | qualification criteria (eg individual |
| | Service Processor role | transaction limits, daily limits, annual |
| | may be performed by | limits, time or place of transaction) |
| | AK, TX, FM/FP or | Enhancement Service expiry date |
| | specialist Enhancement | Account Keeper ID number |
| | Service Processor) | Payer/Receiver Account Number/sub- |
| | | Account number at Account Keeper that |
| | | will be using service |
| 285 | Enhancement Service | Enhancement Service Processor ID |
| | Processor confirms | number |
| | registration to | Registration date |
| | Enhancement Service | Registration expiry date |
| | Provider | Payer/Receiver ID number |
| | | Enhancement Service Provider ID |
| | | Enhancement Service ID number |
| | | Enhancement Service limits or |
| | | qualification criteria (eg individual |
| | | transaction limits, daily limits, annual |
| | | limits, time or place of transaction) |
| | | Enhancement Service expiry date |
| | | Account Keeper ID number |
| | | Payer/Receiver Account Number/sub- |
| | | Account number at Account Keeper that |
| | | will be using service Registration ID |
| | | number |

FIG. 10

| Mes- | | |
|---|---|---|
| sage | Description | Data Elements |
| 401 | Receiver requests | Unique transaction ID |
| | payment | Transaction $ |
| | | Transaction date/time |
| | | Receiver ID |
| | | Location ID |
| | | Terminal ID |
| | | Goods or service SKU (multiple) |
| | | Goods or service description (multiple) |
| 402 | Payer provides | Payer ID |
| | payment particulars. | Card ID (if used) |
| | | Payer Identity token (eg PIN) |
| | | Payer Account Keeper ID |
| | | Payer Account No. of facility to be |
| | | debited |
| 403 | Receiver sends | Date/time |
| | payment particulars | Unique transaction ID |
| | and details of financial | Transaction $ |
| | transaction to TX | Transaction date/time |
| | | Goods or service SKU (optional/multiple) |
| | | Goods or service description |
| | | (optional/multiple) |
| | | Payer ID |
| | | Card ID (if used) |
| | | Payer Identity token (eg PIN) |
| | | Payer Account Keeper ID |
| | | Payer Account No. of facility to be |
| | | debited |
| | | Receiver ID |
| | | Receiver Identity Token |
| | | Location ID |
| | | Terminal ID (if used) |
| | | Receiver Account Keeper ID |
| | | Receiver Account No. of facility to be |
| | | credited |
| 404 | TX sends payment | Date/time |
| | particulars and details | Unique transaction ID |
| | of financial transaction | Transaction $ |
| | to Payer Account | Transaction date/time |
| | Keeper (Alternatively | Goods or service SKU (optional/multiple) |
| | TX authorises | Goods or service description |
| | transaction according | (optional/multiple) |
| | to operating | Payer ID |
| | instructions provided | Card ID (if used) |
| | by Payer Account | Payer Identity token (eg PIN) |
| | Keeper) | Payer Account Keeper ID |
| | | Payer Account No. of facility to be |
| | | debited |
| | | Receiver ID |
| | | Location ID |
| | | Terminal ID (if used) |
| 405 | If transaction outside | Date/time |
| | Payer Account Keeper | Unique transaction ID |
| | Authority, seek | Transaction $ |
| | authorisation authority | Reason for referral to FM/FP |
| | from Fund | Payer ID |
| | Manager/Fund | Account Keeper ID |
| | Provider (if an option) | Account No. of facility to be debited |
| | | Account limits |
| | | Account authorities (eg maximum $ debit |
| | | per day) |
| | | Account activity (eg $ debit current day) |
| | | Fund Manager/Fund Provider ID linked to |
| | | account |
| 406 | Authorisation response | Unique transaction ID |
| | from Fund | Transaction $ |
| | Manager/Fund | Payer ID |
| | Provider to Payer | Account Keeper ID |
| | Account Keeper | Account No. of facility to be debited |
| | | Fund Manager/Fund Provider ID linked to |
| | | account |
| | | Authorisation response |
| 407 | Authorisation response | Unique transaction ID |
| | from Payer Account | Payer ID |
| | Keeper to TX | Authorisation response |
| 408 | Authorisation response | Unique transaction ID |
| | from TX to Receiver | Payer ID |
| | | Authorisation response |
| 409 | TX sends payment | Unique transaction ID |
| | particulars and details | Authorisation response |
| | of financial transaction | Transaction $ |
| | to Receiver Account | Transaction date/time |
| | Keeper (if transaction | Payer ID |
| | approved) | Card ID (if used) |
| | | Payer Account Keeper ID |
| | | Payer Account No. of facility to be |
| | | debited |
| | | Receiver ID |
| | | Receiver Identity Token |
| | | Location ID |
| | | Terminal ID (if used) |
| | | Receiver Account Keeper ID |
| | | Receiver Account No. of facility to be |
| | | credited |
| 421 | Settlement between | Date/time |
| | Payer Account | Payer Account Keeper ID |
| | Keepers and Receiver | Payer Account Keeper Settlement |
| | Account Keepers | Account Number |
| | through TX | Receiver Account Keeper ID |
| | | Receiver Account Keeper Settlement |
| | | Account Number |
| | | Gross $ settlement position of Payer |
| | | Account Keeper to all Receiver Account |
| | | Keepers |
| | | Net $ settlement position of Payer |
| | | Account Keeper to all Receiver Account |
| | | Keepers (Payer Account Keeper could |
| | | also be Receiver Account Keeper) |
| | | Gross $ settlement position of Receiver |
| | | Account Keeper to all Payer Account |
| | | Keepers |
| | | Net $ settlement position of Receiver |
| | | Account Keeper to all Payer Account |
| | | Keepers (Receiver Account Keeper could |
| | | also be Payer Account Keeper) |
| 423 | Settlement between | Date/time |
| | Payer Account | Payer Account Keeper ID |
| | Keepers and Payer | Payer Account Keeper Settlement |
| | Fund Managers/Fund | Account Number |
| | Providers | Fund Manager/Fund Provider ID |
| | | Fund Manager/Fund Provider Settlement |
| | | Account Number |
| | | Gross $ settlement positions of Payer |
| | | Account Keeper to Payer Fund |
| | | Manager/Fund Provider |
| | | Net $ settlement positions of Payer |
| | | Account Keeper to Payer Fund |
| | | Manager/Fund Provider |
| 425 | Settlement between | Date/time |
| | Receiver Account | Receiver Account Keeper ID |
| | Keepers and Receiver | Receiver Account Keeper Settlement |
| | Fund Managers/Fund | Account Number |
| | Providers | Fund Manager/Fund Provider ID |
| | | Fund Manager/Fund Provider Settlement |
| | | Account Number Gross $ settlement |
| | | positions of Receiver Account Keeper to |
| | | Payer Fund Manager/Fund Provider |
| | | Net $ settlement positions of Receiver |
| | | Account Keeper to Receiver Fund |
| | | Manager/Fund Provider |

FIG. 11

| Mes- | | |
|---|---|---|
| sage | Description | Data Elements |
| 431 | Receiver notifies Payer | Statement/bill/invoice ID (not required for |
| | of payment demand | gift/donation) |
| | and Receiver payment | Unique transaction ID |
| | particulars, or Payer | Transaction $ |
| | obtains details of | Transaction date/time |
| | Receiver payment | Goods or service SKU (optional/multiple) |
| | particulars (eg if Payer | (not required for gift/donation) |
| | making gift or | Goods or service description |
| | donation) | (optional/multiple) (not required for |
| | | gift/donation) |
| | | Receiver ID (not required for |
| | | gift/donation) |
| | | Location ID (not required for |
| | | gift/donation) |
| | | Receiver Account Keeper ID |
| | | Receiver Account No. of facility to be |
| | | credited |
| 433 | Payer requests Payer | Statement/bill/invoice ID (not required for |
| | Account Keeper to | gift/donation) |
| | make payment. | Unique transaction ID |
| | | Transaction $ |
| | | Transaction date/time |
| | | Receiver ID (not required for |
| | | gift/donation) |
| | | Location ID (not required for |
| | | gift/donation) |
| | | Receiver Account Keeper ID |
| | | Payer ID |
| | | Card ID (if used) |
| | | Payer Identity token (eg PIN) |
| | | Payer Account Keeper ID |
| | | Payer Account No. of facility to be |
| | | debited |
| 437 | If transaction outside | Date/time |
| | Payer Account Keeper | Unique transaction ID |
| | Authority, seek | Transaction $ |
| | authorisation authority | Payer ID |
| | from Fund | Account Keeper ID |
| | Manager/Fund | Account No. of facility to be debited |
| | Provider (if an option) | Account limits |
| | | Account authorities (eg maximum $ debit |
| | | per day) |
| | | Account activity (eg $ debit current day) |
| | | Fund Manager/Fund Provider ID linked to |
| | | account |
| | | Reason for referral to FM/FP |
| 439 | Authorisation response | Date/time |
| | from Fund | Unique transaction ID |
| | Manager/Fund | Transaction $ |
| | Provider to Payer | Payer ID |
| | Account Keeper | Account Keeper ID |
| | | Account No. of facility to be debited |
| | | Fund Manager/Fund Provider ID linked to |
| | | account |
| | | Authorisation response |
| 441 | Authorisation response | Date/time |
| | from Payer Account | Unique transaction ID |
| | Keeper to Payer | Payer ID |
| | | Authorisation response |
| 443 | Payer Account Keeper | Date/time |
| | sends payment | Statement/bill/invoice ID |
| | particulars and details | Unique transaction ID |
| | of financial transaction | Transaction $ |
| | to TX | Transaction date/time |
| | | Goods or service SKU (optional/multiple) |
| | | Goods or service description |
| | | (optional/multiple) |
| | | Receiver ID |
| | | Location ID |
| | | Receiver Account Keeper ID |
| | | Receiver Account No. of facility to be |
| | | credited |
| | | Payer ID |
| | | Payer Account Keeper ID |
| | | Authorisation response |
| 445 | TX sends payment | Date/time |
| | particulars and details | Statement/bill/invoice ID |
| | of financial transaction | Unique transaction ID |
| | to Receiver Account | Transaction $ |
| | Keeper | Transaction date/time |
| | | Goods or service SKU (optional/multiple) |
| | | Goods or service description |
| | | (optional/multiple) |
| | | Receiver ID |
| | | Location ID |
| | | Receiver Account Keeper ID |
| | | Receiver Account No. of facility to be |
| | | credited |
| | | Payer ID |
| | | Payer Account Keeper ID |
| | | Authorisation response |
| 446 | Receiver Account | Date/time |
| | Keeper sends message | Statement/bill/invoice ID |
| | to Payer's Account | Unique transaction ID |
| | Keeper via TX | Transaction $ |
| | confirming that | Transaction date/time |
| | financial transaction | Receiver ID |
| | has been successfully | Payer ID |
| | posted to Receivers | Payer Account Keeper ID |
| | Account | Confirmation receipt number |
| 447 | TX sends confirmation | Date/time |
| | message to Payer's | Statement/bill/invoice ID |
| | Account Keeper | Unique transaction ID |
| | | Transaction $ |
| | | Transaction date/time |
| | | Receiver ID |
| | | Payer ID |
| | | Payer Account Keeper ID |
| | | Confirmation receipt number |
| 448 | Payer's Account | Date/time |
| | Keeper sends | Statement/bill/invoice ID |
| | confirmation message | Unique transaction ID |
| | to Payer | Transaction $ |
| | | Transaction date/time |
| | | Receiver ID |
| | | Payer ID |
| | | Payer Account Keeper ID |
| | | Confirmation receipt number |
| 449 | Settlement between | Date/time |
| | Payer Account | Payer Account Keeper ID |
| | Keepers and Receiver | Payer Account Keeper Settlement |
| | Account Keepers | Account Number |
| | through TX | Receiver Account Keeper ID |
| | | Receiver Account Keeper Settlement |
| | | Account Number |
| | | Gross $ settlement position of Payer |
| | | Account Keeper to all Receiver Account |
| | | Keepers |
| | | Net $ settlement position of Payer |
| | | Account Keeper to all Receiver Account |
| | | Keepers (Payer Account Keeper could |
| | | also be Receiver Account Keeper) |
| | | Gross $ settlement position of Receiver |
| | | Account Keeper to all Payer Account |
| | | Keepers |
| | | Net $ settlement position of Receiver |
| | | Account Keeper to all Payer Account |
| | | Keepers (Receiver Account Keeper could |
| | | also be Payer Account Keeper) |
| 451 | Settlement between | Date/time |
| | Payer Account | Payer Account Keeper ID |
| | Keepers and Payer | Payer Account Keeper Settlement |
| | Fund Managers/Fund | Account Number |
| | Providers | Fund Manager/Fund Provider ID |
| | | Fund Manager/Fund Provider Settlement |
| | | Account Number |
| | | Gross $ settlement positions of Payer |
| | | Account Keeper to Payer Fund |
| | | Manager/Fund Provider |
| | | Net $ settlement positions of Payer |
| | | Account Keeper to Payer Fund |
| | | Manager/Fund Provider |
| 453 | Settlement between | Date/time |
| | Receiver Account | Receiver Account Keeper ID |
| | Keepers and Receiver | Receiver Account Keeper Settlement |
| | Fund Managers/Fund | Account Number |
| | Providers | Fund Manager/Fund Provider ID |
| | | Fund Manager/Fund Provider Settlement |
| | | Account Number Gross $ settlement |
| | | positions of Receiver Account Keeper to |
| | | Payer Fund Manager/Fund Provider |
| | | Net $ settlement positions of Receiver |
| | | Account Keeper to Receiver Fund |
| | | Manager/Fund Provider |

FIG. 12

| | Description | |
|---|---|---|
| | NOTE: Financial aspects | |
| | of transaction | |
| | occur as per | |
| Mes- | FIG. 10 or | |
| sage | FIG. 11 | Data Elements |
| 501 | Enhancement Service | Enhancement Service Provider ID |
| | criteria to be used to | Date/Time criteria sent |
| | identify qualifying | Service ID number |
| | transactions advised to | Qualification criteria ID number |
| | Enhancement Service | Service delivery indicator: Automated |
| | Processor by | or by request |
| | Enhancement Service | Criteria for identifying qualifying |
| | Provider | transactions |
| | | Date/time criteria effective |
| | | from/to |
| | | Class of Service Provider (eg |
| | | AK, FM/FP ID) |
| | | Transaction $ |
| | | Transaction date/time |
| | | Goods or service SKU |
| | | (optional/multiple) |
| | | Payer or Receiver IDs |
| 503 | Enhancement Service | Enhancement Service Processor ID |
| | criteria to be used to | Enhancement Service Provider ID |
| | identify qualifying | Date/Time criteria sent |
| | transactions advised to | Qualification criteria ID number |
| | TX by Enhancement | Criteria for identifying qualifying |
| | Service Processor | transactions |
| | | Date/time criteria effective |
| | | from/to |
| | | Class of Service Provider (eg |
| | | AK, FM/FP ID) |
| | | Transaction $ |
| | | Transaction date/time |
| | | Goods or service SKU |
| | | (optional/multiple) |
| | | Payer or Receiver IDs |
| 505 | TX transmits qualifying | Enhancement Service Processor ID |
| | transactions to | Qualification criteria ID number |
| | Enhancement Service | Transactions details |
| | Processor | Transaction $ |
| | | Transaction date/time |
| | | Goods or service SKU |
| | | (optional/multiple) |
| | | Payer or Receiver IDs (eg card |
| | | number) |
| | | Payer or Receiver Account |
| | | Keeper ID |
| | | Payer or Receiver Account No. |
| | | transaction debited to |
| | | Receiver ID |
| | | Location ID |
| 507 | Enhancement Service | Service Provider ID |
| | Processor sends details | Service type ID |
| | of qualifying | Value of service accrued |
| | transactions to | Payer or Receiver ID |
| | Enhancement Service | Card ID (if used) |
| | Provider and value of | Payer or Receiver Account Keeper ID |
| | service accrued. | Payer or Receiver Account No. |
| | | transaction debited to |
| | | Payer or Receiver Fund Manager/Fund |
| | | Provider ID for Payer or Receiver |
| | | Account |
| | | Unique transaction ID |
| | | Transaction $ |
| | | Transaction date/time |
| | | Goods or service SKU (optional/ |
| | | multiple) |
| | | Goods or service description |
| | | (optional/multiple) |
| | | Receiver ID |
| | | Location ID |
| 509 | Payer or Receiver | Payer or Receiver ID |
| | requests details of | Service ID |
| | qualifying transactions | Service Provider ID number |
| | and value of service | |
| | accrued from | |
| | Enhancement Service | |
| | Provider. | |
| 511 | Enhancement Service | Payer or Receiver ID |
| | Provider provides | Service ID (if used) |
| | details of qualifying | Service Provider ID number |
| | transactions and value | Value of service accrued |
| | of service accrued to | Period of service accrual |
| | Payer or Receiver | Message from Enhancement Service |
| | | Provider |
| 513 | Payer or Receiver | Service Provider ID |
| | requests service | Service type ID |
| | delivery (required if non | Payer or Receiver ID |
| | automated delivery of | Value of service requested |
| | service eg extended | |
| | product warranty) | |
| 515 | Enhancement Service | Service Provider ID |
| | Provider checks against | Service type ID |
| | accrued service earned | Payer or Receiver ID |
| | and delivers benefit to | Value of service requested |
| | Payer or Receiver | Value of service accrued |

FIG. 13

| | Description | |
|---|---|---|
| | NOTE: Financial | |
| | aspects | |
| | of transaction | |
| Mes- | occur as per | |
| sage | FIG. 10 or 11 | Data Elements |
| 571 | Enhancement Service | Enhancement Service Provider ID |
| | criteria to be used to | Date/Time criteria sent |
| | identify qualifying | Service ID |
| | transactions advised to | Service delivery indicator: Automated or |
| | Enhancement Service | by request |
| | Processor by | Criteria for identifying qualifying |
| | Enhancement Service | transactions |
| | Provider | Date/time criteria effective |
| | | from/to |
| | | Class of Service Provider (eg |
| | | AK, FM/FP ID) |
| | | Transaction $ |
| | | Transaction date/time |
| | | Goods or service SKU |
| | | (optional/multiple) |
| | | Payer IDs |
| 573 | Enhancement Service | Enhancement Service Processor ID |
| | criteria to be used to | Enhancement Service Provider ID |
| | identify qualifying | Date/Time criteria sent |
| | transactions advised to | Qualification criteria ID number |
| | TX by Enhancement | Criteria for identifying qualifying |
| | Service Processor | transactions |
| | | Date/time criteria effective |
| | | from/to |
| | | Class of Service Provider (eg |
| | | AK, FM/FP ID) |
| | | Transaction $ |
| | | Transaction date/time |
| | | Goods or service SKU |
| | | (optional/multiple) |
| | | Payer IDs |
| 575 | TX transmits | Enhancement Service Processor ID |
| | qualifying transactions | Qualification criteria ID number |
| | to Enhancement | Transactions details |
| | Service Processor | Transaction $ |
| | | Transaction date/time |
| | | Goods or service SKU |
| | | (optional/multiple) |
| | | Payer IDs (eg card number) |
| | | Payer Account Keeper ID |
| | | Payer Account No. transaction |
| | | debited to |
| | | Receiver ID |
| | | Location ID |
| 577 | Enhancement Service | Service Provider ID |
| | Processor sends details | Service type ID |
| | of qualifying | Value of service accrued |
| | transactions to | Payer ID |
| | Receiver Enhancement | Payer Account Keeper ID |
| | Service Provider (if | Payer Account No. transaction debited to |
| | also performing | Payer Fund Manager/Fund provider ID |
| | accrual calculation | for Payer Account |
| | message may be | Unique transaction ID |
| | limited to value of | Transaction $ |
| | service accrued) | Transaction date/time |
| | | Goods or service SKU (optional/multiple) |
| | | Goods or service description |
| | | (optional/multiple) |
| | | Receiver ID |
| | | Receiver Account Keeper ID |
| | | Receiver Account No. transaction debited |
| | | to |
| 579 | Payer requests details | Payer ID |
| | of qualifying | Service ID |
| | transactions and value | Service Provider ID number |
| | of service accrued | |
| | from Enhancement | |
| | Service Provider. | |
| 581 | Enhancement Service | Payer ID |
| | Provider provides | Service ID (if used) |
| | details of qualifying | Service Provider ID number |
| | transactions and value | Value of service accrued |
| | of service accrued to | Period of service accrual |
| | Payer | Message from Enhancement Service |
| | | Provider |
| 583 | Payer requests service | Service Provider ID |
| | delivery (required if | Service type ID |
| | non automated | Payer ID |
| | delivery of service eg | Receiver ID |
| | extended product | Value of service requested |
| | warranty, or | |
| | redemption of accrued | |
| | loyalty points) | |
| 585 | Enhancement Service | Service Provider ID |
| | Provider or | Service type ID |
| | Enhancement Service | Payer ID |
| | Processor check | Receiver ID |
| | against accrued | Value of service requested |
| | service earned and | Value of service accrued |
| | delivers benefit to | |
| | Payer | |
| 597 | Enhancement Service | Service Provider ID |
| | Provider advises | Service type ID |
| | Receiver the value of | Payer ID |
| | services accrued and | Receiver ID |
| | services delivered to | Value of service delivered |
| | Payers | |
| 599 | Receiver settles with | Service Provider ID |
| | Enhancement Service | Service type ID |
| | Provider in accordance | Payer ID |
| | with their commercial | Receiver ID |
| | agreement | Value of service delivered |

What is claimed is:

1. A payment transaction system, including a transaction exchange for:
(a) registering and certifying account keepers for maintaining accounts and authorising payment transactions on behalf of entities;
(b) storing account keeper identification (ID) data;
(c) receiving a payment transaction, said transaction including ID data for a registered account keeper and an account associated with a payer making a payment of the transaction, and ID data for a registered account keeper and an account associated with a receiver receiving the payment;
(d) determining validity of the transaction based on the ID data; and
(e) authorising the transaction with the account keeper associated with the payer.

2. A payment transaction system, as claimed in claim 1, wherein said transaction exchange includes:
a database server maintaining records of the received payment transactions and the registered entities, including the ID data associated with the registered entities; and
a message processor for processing messages from and sending messages to the account keepers, and for performing said registering, receiving, determining and authorising.

3. A payment transaction system as claimed in claim 1, wherein said payment transaction is completed without fees being exchanged between said account keepers.

4. A payment transaction system as claimed in claim 1, wherein said transaction exchange is adapted for registering and certifying at least one payment enabler for use in initiating a payment transaction, and storing payment enabler ID data, and receiving said payment transaction from a registered payment enabler.

5. A payment transaction system as claimed in claim 1, wherein said transaction exchange is adapted for registering a guarantor, and storing guarantor ID data.

6. A payment transaction system as claimed in claim 5, wherein registering the account keepers includes obtaining guarantee data from at least one registered guarantor.

7. A payment transaction system as claimed in claim 1, wherein said transaction exchange is adapted for registering an identity authenticator, and storing identity authenticator ID data.

8. A payment transaction system as claimed in claim 7, wherein the registered account keeper for the payer establishes said account for said payer after confirming the identity of said payer with a registered identity authenticator.

9. A payment transaction system as claimed in claim 7, wherein the registered account keeper for the receiver establishes said account for said receiver after confirming the identity of said receiver with a registered identity authenticator.

10. A payment transaction system as claimed in claim 6, wherein the registered account keeper for the payer establishes said account for said payer after confirming the identity of said payer with a registered identity authenticator and obtaining guarantee data from at least one registered guarantor.

11. A payment transaction system as claimed in claim 6, wherein the registered account keeper for the receiver establishes said account for the receiver after confirming the identity of said receiver with a registered identity authenticator and obtaining guarantee data from at least one registered guarantor.

12. A payment transaction system as claimed in claim 1, wherein said account keepers are adapted to associate said accounts with a financial facility provided by a financial facility provider.

13. A payment transaction system as claimed in claim 1, including an enhancement service processor for processing said payment transaction to determine if said transaction qualifies for an enhancement service for an entity.

14. A payment transaction system as claimed in claim 13, wherein a payer or receiver obtains said enhancement service from an enhancement service provider without reference to any other entity of the system.

15. A payment transaction system, including:
at least one payer entity associated with making a payment of a payment transaction;
at least one receiver entity associated with receiving the payment of the transaction;
a payer account keeper for managing an account on behalf of a payer;
a receiver account keeper for managing an account on behalf of a receiver;
a financial facility provider for providing a financial facility associated with at least one of the accounts;
at least one payment enabler for use in initiating the transaction; and
a transaction exchange for registering and certifying the account keepers, and for authorising the payment transaction with the payer account keeper.

16. A payment transaction system as claimed in claim 15, wherein said transaction exchange is adapted for registering and certifying the payment enabler.

17. A payment transaction system as claimed in claim 15, wherein a record of the authorised payment transaction is stored for said receiver account keeper.

18. A payment transaction system as claimed in claim 17, wherein said receiver account keeper validates the transaction.

19. A payment transaction system including:
payment transaction acceptance devices;
service providers providing payment transaction enhancement services to receivers and payers;
account keepers providing payment transaction accounts and processing payment transactions for payers and receivers; and
a transaction exchange for processing payment transactions accepted by said devices and forwarding processed transactions to said account keepers for authorising payment.

20. A system as claimed in claim 19, wherein said transaction exchange sends to said service providers, data for transactions qualifying for said enhancement services.

21. A system as claimed in claim 19, wherein a payer or a receiver connects to said transaction exchange, an associated account keeper, or an associated financial facility provider to access services of selected ones of a plurality of service providers.

22. A system as claimed in claim 21, wherein the service providers include different guarantors, identity authenticators, account keepers, payment enabler providers, financial facility providers, and enhancement service providers.

23. A payment transaction process, including:
(a) registering and certifying account keepers for maintaining accounts and authorising payment transactions on behalf of entities;
(b) storing account keeper identification (ID) data;
(c) receiving a payment transaction, said transaction including ID data for a registered account keeper and an account associated with a payer making a payment of the transaction, and ID data for a registered account keeper and an account associated with a receiver receiving the payment;
(d) determining validity of the transaction based on the ID data; and
(e) authorising the transaction with the account keeper associated with the payer.

24. A payment transaction process, as claimed in claim 23, including maintaining records of the received payment transactions and the registered entities, including the ID data associated with the registered entities.

25. A payment transaction process as claimed in claim 23, including completing said payment transaction without fees being exchanged between said account keepers.

26. A payment transaction process as claimed claim 23, including registering and certifying at least one payment enabler for use in initiating a payment transaction, and storing payment enabler ID data, and receiving said payment transaction from a registered payment enabler.

27. A payment transaction process as claimed in claim 23, including registering a guarantor, and storing guarantor ID data.

28. A payment transaction process as claimed in claim 27, wherein registering the account keepers includes obtaining guarantee data from at least one registered guarantor.

29. A payment transaction process as claimed in claim 23, including registering an identity authenticator, and storing identity authenticator ID data.

30. A payment transaction process as claimed in claim 29, wherein the registered account keeper for the payer establishes said account for said payer after confirming the identity of said payer with a registered identity authenticator.

31. A payment transaction process as claimed in claim 29, wherein the registered account keeper for the receiver establishes said account for said receiver after confirming the identity of said receiver with a registered identity authenticator.

32. A payment transaction process as claimed in claim 28, wherein the registered account keeper for the payer establishes said account for said payer after confirming the identity of said payer with a registered identity authenticator and obtaining guarantee data from at least one registered guarantor.

33. A payment transaction process as claimed in claim 28, wherein the registered account keeper for the receiver establishes said account for the receiver after confirming the identity of said receiver with a registered identity authenticator and obtaining guarantee data from at least one registered guarantor.

34. A payment transaction process as claimed in claim 23, wherein said account keepers associate said accounts with a financial facility provided by a financial facility provider.

35. A payment transaction process as claimed in claim 23, including processing said payment transaction to determine if said transaction qualifies for an enhancement service for an entity.

36. A payment transaction process as claimed in claim 35, wherein a payer or receiver obtains said enhancement service from an enhancement service provider without reference to any other entity.

37. A payment transaction process, including:
a payer entity making a payment of a payment transaction;
a receiver entity receiving the payment of the transaction;
a payer account keeper managing an account on behalf of a payer;
a receiver account keeper managing an account on behalf of a receiver;
a financial facility provider providing a financial facility associated with at least one of the accounts;
a payment enabler initiating the transaction; and
a transaction exchange, having registered and certified the account keepers, authorising the payment transaction with the payer account keeper.

38. A payment transaction process as claimed in claim 37, wherein registering and certifying the payment enabler with said transaction exchange.

39. A payment transaction process as claimed in claim 38, including storing a record of the authorised payment transaction for said receiver account keeper.

40. A payment transaction process as claimed in claim 39, wherein said receiver account keeper validates the transaction.

41. A payment transaction process including:
service providers providing payment transaction enhancement services to receivers and payers;
account keepers providing payment transaction accounts and processing payment transactions for payers and receivers; and
a transaction exchange processing payment transactions accepted by payment transaction acceptance devices and forwarding processed transactions to said account keepers to authorise payment.

42. A process as claimed in claim 41, wherein said transaction exchange sends to said service providers, data for transactions qualifying for said enhancement services.

43. A process as claimed in claim 42, wherein a payer or a receiver connects to a transaction exchange, an associated account keeper, or an associated financial facility provider to access services of selected ones of a plurality of service providers.

44. A process as claimed in claim 43, wherein the service providers include different guarantors, identity authenticators, account keepers, payment enabler providers, financial facility providers, and enhancement service providers.
